(19) United States
(12) Patent Application Publication
(10) Pub. No.: US 2014/0188595 A1
(43) Pub. Date: Jul. 3, 2014

(54) EMAIL MARKETING SYSTEM AND METHOD

(71) Applicant: Robert Jacobs, Franklin, NY (US)

(72) Inventor: Robert Jacobs, Franklin, NY (US)

(21) Appl. No.: 14/142,647

(22) Filed: Dec. 27, 2013

Related U.S. Application Data
(60) Provisional application No. 61/746,717, filed on Dec. 28, 2012.

(51) Int. Cl. G06Q 30/02

(52) U.S. Cl. CPC G06Q 30/0244; G06Q 30/0242; G06Q 30/0251
USPC 705/14.43; 705/14.41; 705/14.49

(57) ABSTRACT

A system and method for providing rules-based or algorithm-based automated response optimization in the email-marketing environment is provided. The system and method increases email open, click through, and fulfillment rates for its newsletter advertisers, national retailers, manufacturers, non-profits and the like (“Customers”). Individuals who receive emails from any of the Customers will become a Member through a simple enrollment process. The system and method rewards Members for opening, clicking through and/or fulfilling emails with a proprietary currency and trading floor. The rewards may be exchanges on the trading floor for coupons, goods, services and actual cash.

### CROSS-REFERENCE TO RELATED APPLICATION

This application claims the benefit of U.S. Provisional Patent Application No. 61/746,717, filed on Dec. 28, 2012, the entire contents of which are herein incorporated by reference.

### FIELD OF THE INVENTION

The present invention relates generally to email marketing.

### BACKGROUND OF THE INVENTION

Email messaging is a powerful and cost-effective way to market products or services and build relationships with customers and prospects. It is no longer an “emerging” marketing channel, but has instead become a required tool for any successful marketing plan. The email advertising industry is growing at a compound annual growth rate of 20% and is projected to reach $18 billion in 2013. According to Price Waterhouse Coopers, the first quarter revenue growth for 2012 was $8.46 billion-$1.1 billion and 15% greater than the first quarter results for 2011 ($7.36 billion). The half year results were similar, with 2012 logging $17.03 billion compared to $14.94 billion for the same period in 2011 (increases of $2.1 and 14%). Email marketing can be accomplished at substantially lower costs than other means.

Email reaches a wider audience in a shorter time period for far less money than needed to invest in a comparable direct marketing campaign. Email marketing is not “one-off” spot communication, but rather a sustained, evolving dialogue that builds and maintains customer relationships. A marketing email consists of the list of email addresses to which the mailing is to be sent and the content to be sent to those addresses. Content itself can contain text, pictures, multi-media data, HTML, scripts, and the like, as well as links that can be clicked on by the email recipient and that lead to Internet URLs that themselves contain information and/or items for sale.

Statistics can be automatically accumulated about the number of messages sent and what happens to them. These statistics are available in the form of reports generated by the computer-based mailing application. Reports contain information not only on how many emails were sent, but also on what happened to them (“responses” generated), i.e., how many were actually received, how many failed to be delivered, how many were opened and read by recipients, how many opt-out requests were made (requests to be removed from a mailing list), how many times links within the email were clicked on so that the recipient could view a website, how many email replies were generated, and generally how “successful” the email was.

Numerous other events can be tracked and used to gauge a successful email, such as the time spent at a clicked through website, signing on to a clicked through website, numbers of purchases made, and other similar events. Such events are typically referred to collectively as “response events” or just “responses.” A “conversion” or “conversion event” is a type of response event generally encompassing any specific action by a recipient that was the intended objective of the marketer, such as an online purchase of goods or services made by the email recipient as a result of the email. Other conversion events include other types of transactions that are completed online, such as, online registrations, filling out surveys, etc., and/or offline activities, such as creating brand awareness, store visits, etc. The use herein of the expression “conversion” or “conversion event” is intended to include all such responses. Marketers seek to generate as many response events as possible.

### SUMMARY OF THE INVENTION

The system and method of the present invention focuses on email newsletters, news bulletins and other email “news” providers. The email newsletter business has grown in the last 5 years from $1 billion in gross revenues to $2.6 billion. This increase is mainly due to advertiser's increasing appetite for Internet Advertising.

The proliferation of email newsletters and other email “advertorial” advertising has created a need for the system and method of this invention. Marketers are desperate to increase open rates and advertisers are eager to pay more for higher open rates just as television and radio networks are always trying to increase ratings and advertisers, as always, are eager to pay for those higher ratings.

The fundamental email advertising industry metrics are comprised of:
1. The open rate (the “OR”) is the ratio between the number of registered opens to the number of emails sent.
2. Generally, if the opener leaves the page in 3 seconds or less the email is not counted as opened.
3. If the opener stays on the page for more than 10 seconds, it is also counted as read. Some email service providers, as well as some marketers, count only the number of emails actually delivered when calculating the open rate.

The click through rate (the “CTR”) is the ratio between the number of clicks after open to the number of emails opened. For example, if an email was opened by 100 subscribers and 30 of those subscribers clicked on a link, then the CTR would be 30%.

The conversion rate (fill) is the ratio between the number of conversions to the number of clicks. A conversion can be anything, such as a sale, request for more information, additional subscription, or whatever the subscriber is asked to do. For example, if, of those 30 subscribers that clicked on a link, 3 purchased something, then the conversion rate would be 10% (a few marketers divide the number converted by the original mailing which in this example would be 3%).

Click through and conversion rates are the most important indicators of email performance and drive the action from each e-correspondence. The average rates thru June 2011 are listed in the table below.

TABLE 1
Average Rages - June 2011

| | |
|---|---|
| Average Open Rate | 23.3% |
| Average Click Thru Rate | 5.9% |
| Average Delivery Rate | 96.0% |

Q1 Open Rate Increased:

| | |
|---|---|
| Qtr over Qtr = | 5.6% |
| Year over Year = | 4.2% |

Source: Epsilon Q1 2011 Email Trends & Benchmarks

Considerable time, energy, and brainpower are being focused on raising the above rates. E-advertising professionals recommend a myriad of strategies to improve these rates. The ideas include: scrubbing email lists, opting-in, double opting-in, subject line strategies, such as using all CAPS, or lists of words to avoid, what days of the week produce greater responses, what time of the day is best to send an email, and so on. All of these are strategies to entice the receiver to open an unrequested email. And when the results of all these strategies are reviewed, the increase in response rates seem hardly worth the effort. Any improvements are generally limited to mere fractions of a percent.

According to Exact Target's “Email X-Factor Study” (2010), people open unsolicited emails hoping to get something for free or at a discount. 67% want a discount or promotion, 55% want something for free. Only 14% want to interact with the brand:

TABLE 2
Email Opener Motivation

67% want look for discounts & promotions.
55% want a freebie.
14% want to interact with the brand.
Source: Exact Target “Email X-Factor Study” (2010)

Email marketing through newsletters, bulletins, advertorials, and other e-correspondence is growing at a pace that exceeds 20% per year for the last 5 years. The domestic market alone has e-correspondence made up of over 125,000 different newsletter or bulletin type pieces that each contain some form of marketing embedded within. According to PWC, the market has grown from $9.6 billion to $16.6 in just 5 years. This is an increase of 73%.

Retailers are seeking to increase online sales, increase the amount of the average sale, and also to increase traffic at brick and mortar locations. Manufacturers are seeking to increase their new customer base while retaining their loyal customer base. Non-profits want to increase donations. All are faced with the same dilemma—faced with more and more unsolicited emails, people are simply ignoring most of it. 2011 open rates by industry break down as follows:

TABLE 3
Typical Open Rates (%)

| | | |
|---|---|---|
| | 100% | |
| | 90% | |
| | 80% | |
| | 70% | |
| | 60% | |
| | 50% | Manufacturing |
| Non profit | 40% | Religious |
| Travel | | Art |
| | | Government |
| Health | 30% | Education |
| Real estate | | Photography |
| Technology | 20% | Publishing & Media |
| Insurance | | Marketing |
| | | E-commerce |
| | 10% | |

There are certainly some broad trends in open rates. As company and list size goes up, the open rate tends to fall; possibly because smaller companies are more likely to have personal relationships with their list subscribers. Companies and organizations that are focusing on enthusiasts and supporters, like churches, sport teams and non-profits enjoy higher open rates. More specific niche topics also typically have higher open rates than emails on broader topics.

The present invention will significantly increase email open, click through, and fulfillment rates for its newsletter advertisers, national retailers, manufacturers, non-profits, and the like (“Customers”). Any individual who receives an email from any Customer will become a Member through a simple enrollment process. The turn-key system and method of the invention will include rewarding Members for opening, clicking through or fulfilling emails with the proprietary currency. This currency will have real value and can be traded through a proprietary trading floor for coupons, merchandise, cash, etc.

In one embodiment of the invention, a computerized method is provided of optimizing response of an email marketing campaign. The method comprising creating a marketing message in the form of an email, sending the email to a predetermined number of targeted recipients, electronically tracking at least one selected response event occurring as the email is being sent to the targeted recipients, and providing an incentive to the recipients for performing the selected response event. The selected response event may be comprise deliverability rate, open rate, click through rate, conversion rate, purchase rate, reply rate, and unsubscribe rate.

In another embodiment of the invention, a system is provided for optimizing selected responses of an email marketing campaign. The system comprising: electronic means for creating a marketing message in the form of an email; at least one server in communication with the electronic means for sending the email to a predetermined number of targeted recipients; means for electronically tracking at least one selected response event occurring as the email is being sent to the targeted recipients; and means for transferring currency to the targeted recipients in exchange for their performance of the selected response event. The system may further comprise a trading platform that may enable the selling or exchanging of earned currency for goods or services.

In yet another embodiment of the invention, a system for optimizing an email marketing campaign is provided. The system comprising a database for electronically storing a list of email addresses of targeted recipients of an email containing a marketing message, an email server coupled to the database for sending the email to targeted recipients and for receiving electronic signals representative of at least one selected response event by the targeted recipients; and computer-based software coupled to the email server for electronically measuring the at least one selected response event as they occur; the computer based software including means for automatically transferring currency into accounts associated with the targeted recipients as compensation for the measured selected response event. The system may further comprise a trading platform that enables the selling or exchanging of earned currency for goods or services.

In yet another embodiment of the invention, a computerized method for providing an email reward trading platform is provided. The method comprising determining whether an email recipient performed at least one predetermined selected response event, depositing currency into an account of the email recipient based on performance of the predetermined selected response event, receiving notification from the email recipient to exchange the currency for at least one good or service; and exchanging the currency for the at least one good or service.

### BRIEF DESCRIPTION OF THE DRAWINGS

FIG. 1 shows an exemplary flow diagram for the email marketing and incentive system and method.

FIG. 2 shows an exemplary flow diagram wherein the email marketing and incentive system and method is controlled by a third party.

### DETAILED DESCRIPTION OF THE INVENTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The email marketing system and method of the present invention will increase open, click through, and fill rates by providing incentives in the form of currency to Members (i.e., individuals who receives the emails). A trading platform allows Members to sell or exchange their earned currency for goods and services. In order to receive currency, the Member must open the email, scroll down to a certain identified button, and click. In order to receive additional click through currency, the member must click on an advertisement and then find and click on the identified button in the advertisement. In order to receive additional fill currency, the Member must click on the identified button and make a purchase.

The email marketing system can be run by a Customer (e.g., newsletter advertiser, national retailer, manufacturer, non-profits, and the like) directly, or be controlled by a third party. When Customers control the backend of their module, they can add, alter, or delete their offers and deals on a real time basis. Members will have the opportunity to buy, sell or trade their currency with other Members or directly with retail, manufacturing or non-profit Customers. Each Member and Customer will be assigned a seat on the trading floor from which each will be able to see all the activity on the floor. The Trading Floor will be a link from a Customer or third party web site and is a standalone component. Its design will resemble a Wall Street trading floor.

The Trading Floor will have many different facets. For example:

Each Member will have the opportunity to buy, trade or sell currency. The sell price will be established by the Members, retailers, manufacturers and charities on a bid/ask basis.

Members will be allowed to apply to become a market maker. There will be specific qualifications to become a market maker (e.g., financial ability, account balances, history on the floor). Market Makers will be seated in a special area of the floor and will be able to accept bids and put up an ask for quantities of currency.

Retailers will offer additional currency for certain purchases and additional savings.

Manufacturers will offer currency for redeeming coupons and trying and reviewing new products.

Charities will accept currency as donations and will offer currency for additional cash donations.

Newsletter owners will offer currency for sign-ups.

The system of the present invention may comprise a database, an email server, and a computer based software. The database may electronically store a list of email addresses of targeted recipients or Members of an email containing a marketing message. The email server may be coupled to the database for sending the email to the targeted recipients or Members and for receiving electronic signals representative of at least one selected response event by the targeted recipients or Members. The computer based software may be coupled to the email server for electronically measuring the at least one selected response event as it occurs. The computer based software may cause for automatic transfer of currency into accounts associated with the targeted recipients as compensation for the measured selected response event.

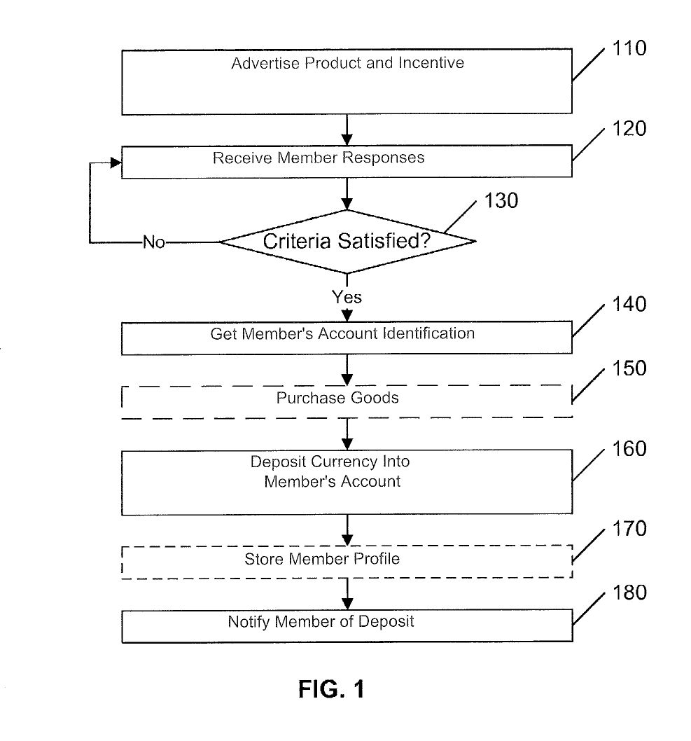

Turning now to FIG. 1, an exemplary flow diagram for the email marketing and incentive system is provided. For the purposes of this disclosure, the term “Member” is used hereinafter to identify the “target” of the incentive program; that is, the person from whom a desired action is solicited, such as a purchase, a subscription, a response, and so on.

At 110, the offer for the actual goods and/or services and the incentive of obtaining currency is advertised to the Member in an email.

At 120, the Member's responses are received and processed. Such responses may include typical web-page interactions, click throughs, searches, and so on, all of which can lead to an award of currency. At some point, the Member may, for example, make a purchase at 150, and, at 130, the system will proceed to satisfy the offer.

To initiate the redemption process, the system queries the Member to obtain the information necessary to effect the transfer of currency into the Member's account, at 140. The particular procedure for accessing the Member's account and providing a deposit will be dependent upon the particular environment associated with the account. Most environments allow users to “gift” credits from one user to another, and in a preferred embodiment, the provider of the incentive establishes a relationship with a third party provider of the environment to facilitate such transfers. At 160, the system deposits currency into Member's account.

In a preferred embodiment of this invention, the system also requests permission to obtain the user's email address and to access the user's profile information. The email address is nominally requested for sending a confirmation email regarding the deposit of currency, but also serves to allow the retailer to send targeted emails to the Member with other offers and incentives and to validate the email inputted to ensure quality leads and information about the Member. The Member's profile information may be stored at 170 and subsequently used to determine the Member's preferences and demographics, and to facilitate selective targeting and personalization. The profile information may also be used to identify goods and/or services that the Member may have an interest in, based on gender, age, expressed interests, and so on.

At 180, the Member is notified of the currency deposit. In preferred embodiments, the Member may be provided the opportunity to publish an opinion of the transaction, rate the advertisement or product, etc. The Member's agreement to publish an opinion may also result in the deposit of additional currency into the Member's account.

In a preferred embodiment of this invention, a third party manager provides the interface between the Customer (e.g., retailer) and the Member. Preferably, the third party manager warrants the transfer of currency to the Customer and the exchange of goods and services to the Member.

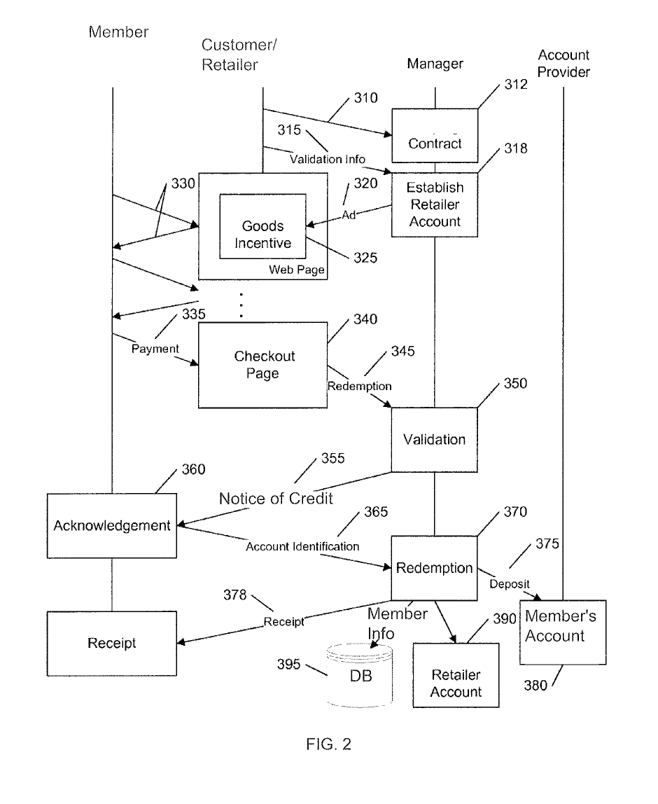

FIG. 2 illustrates an exemplary flow diagram for an email marketing and incentive system using the third party manager.

By way of example, a retailer that desires to add an incentive program to an advertising program for goods contacts 310 the third party manager and enters into a contract 312 with the manager. The contract may take any number of forms, including a fixed price contract, but in general, a commission-based contract is particularly well suited for marketing campaigns. Generally, the campaign manager will establish an account 318 for the retailer, with a fixed ceiling amount that sets an upper limit to the cost of providing the currency incentive. Associated with this account is confidential information 315 associated with the retailer that serves to validate transactions related to the retailer's account, as detailed further below. Depending upon the particular contract, the retailer may be required to provide a down payment of actual funds to support the campaign, and/or to replenish the actual funds as the balance in the account is drawn down by the purchase of the virtual goods that are transferred to the clients.

In one embodiment of this invention, the third party manager provides 320 the advertisement 325 for incentive. The Member interacts 330 with the retailer's web site, and, in this example, eventually executes a purchase for an actual object and remits payment 335 while interacting with the checkout page 340. Upon completion of the purchase, the retailer notifies 345 the manager that the purchase has been completed, and instructs the manager to transfer currency to the Member. Upon receipt of the parameters in the redemption message 345 from the retailer, the manager validates that the redemption message is a proper and authorized redemption request, at 350.

To validate that the redemption message was created by the particular vendor identified in the redemption message, the manager decrypts the encrypted element using the decryption process corresponding to the encrypting process used by the retailer. If the communicated token was a proper encryption of the unique identifier using the retailer's key, the result of this operation on the token at the third party manager site will be the unique identifier. If the determined result does not match the communicated unique identifier, the redemption is not executed and the process is terminated with an “invalid redemption request” error message.

If the determined result matches the unique identifier, the manager verifies that this redemption request is not a duplicate request by checking the retailer's account for this unique identifier. As detailed below, when a redemption request is granted, the manager records the redemption in the retailer's account, including the unique identifier. If the current unique identifier is already entered in the retailer's account, the redemption is not executed and the process is terminated with an “already redeemed” error message.

After validating that the redemption request is authorized by the retailer, and not a repeat of a previously granted redemption request, the manager notifies 355 the Member that the redemption process is underway. The Member acknowledges the transaction by providing the necessary information 365 for accessing the Member's account 380. Other environments may provide different protocols and Application Program Interfaces (APIs) for accessing a Member's account to make currency deposits.

Upon receipt of the identification of the Member's account, the third party manager deposits 375 the offered currency into the Member's account 380, notifies 378 the Member of the deposit, and records 390 this deposit in the retailer's account.

The recordation 390 of the deposit in the retailer's account includes the details associated with the redemption, such as the unique identifier of the redemption, and also effects a debit to the retailer's account, reducing the amount available to fund subsequent redemptions. If this redemption causes the cost of the campaign to reach (or approach) the aforementioned ceiling, the retailer is notified, and offered the opportunity to increase the ceiling to continue the incentive program.

As noted above, in addition to gaining access to the Member's account to deposit the currency, the manager also accesses the information that the Member has allowed the manager to access, such as the client's basic information (name, gender, age, etc.) and profile information (likes and dislikes, favorite activities, etc.). In a preferred embodiment of this invention, the third party manager maintains a client database 395 for storing this information for each client. In this manner, the manager may develop incentive campaigns that are specifically targeted to particular clients, or groups of clients.

While the above description contains many specific details, these should not be construed as limitations on the scope of the invention, but rather as an exemplification of preferred embodiments thereof. Other variations are possible. Accordingly, the scope of the invention should be determined not by the preferred embodiment illustrated, but by the appended claims and their legal equivalents, as put forth hereinafter.

1. A computerized method of optimizing response of an email marketing campaign comprising:
creating a marketing message in the form of an email;
sending said email to a predetermined number of targeted recipients;
electronically tracking at least one selected response event occurring as said email is being sent to said targeted recipients; and
providing an incentive to said recipients for performing said selected response event.

2. The method of claim 1 wherein said selected response event is selected from the group consisting of: deliverability rate; open rate; click through rate; conversion rate; purchase rate; reply rate; and unsubscribe rate.

3. A system for optimizing selected responses of an email marketing campaign comprising:
electronic means for creating a marketing message in the form of an email;
at least one server in communication with said electronic means for sending said email to a predetermined number of targeted recipients;
means for electronically tracking at least one selected response event occurring as said email is being sent to said targeted recipients; and
means for transferring currency to said targeted recipients in exchange for their performance of said selected response event.

4. The system according to claim 3, wherein said system further comprises a trading platform.

5. The system according to claim 4, wherein said trading platform enables the selling or exchanging of earned currency for goods or services.

6. A system for optimizing an email marketing campaign comprising:
a database for electronically storing a list of email addresses of targeted recipients of an email containing a marketing message;
an email server coupled to said database for sending said email to targeted recipients and for receiving electronic signals representative of at least one selected response event by said targeted recipients; and
computer based software coupled to said email server for electronically measuring said at least one selected response event as they occur; said computer based software including means for automatically transferring currency into accounts associated with said targeted recipients as compensation for said measured selected response event.

7. The system according to claim 6, wherein said system further comprises a trading platform.

8. The system according to claim 7, wherein said trading platform enables the selling or exchanging of earned currency for goods or services.

9. A computerized method for providing an email reward trading platform, comprising:
determining whether an email recipient performed at least one predetermined selected response event;
depositing currency into an account of said email recipient based on performance of said predetermined selected response event;
receiving notification from said email recipient to exchange said currency for at least one good or service; and
exchanging said currency for said at least one good or service.
